(19) United States
(12) Patent Application Publication
(10) Pub. No.: US 2026/0353277 A1
(43) Pub. Date: Nov. 5, 2026

(54) POWER SAVE MODE PERIOD NEGOTIATION METHOD, AND ELECTRONIC DEVICE AND STORAGE MEDIUM

(71) Applicant: Beijing Xiaomi Mobile Software Co., Ltd., Beijing (CN)

(72) Inventor: Xiandong DONG, Beijing (CN)

(73) Assignee: Beijing Xiaomi Mobile Software Co., Ltd., Beijing (CN)

(21) Appl. No.: 19/485,947

(22) PCT Filed: May 19, 2023
(86) PCT No.: PCT/CN2023/095386

§ 371 Date: Nov. 19, 2025

(51) Int. Cl. H04W 52/02

(52) U.S. Cl. CPC H04W 52/0206

(57) ABSTRACT

The embodiments of the present disclosure relate to the technical field of mobile communications. Provided are a power save mode period negotiation method, and an electronic device and a storage medium. The power save mode period negotiation method is applied to a first AP. The method comprises: acquiring R-TWT SP information of a neighbor AP; and according to an acquisition mode for the R-TWT SP information, scheduling a power save mode period of the first AP under at least one link, wherein the power save mode period overlaps with or does not overlap with a time which is indicated by the R-TWT SP information.

### CROSS REFERENCE

The present application is a national phase application of International Application No. PCT/CN2023/095386, filed on May 19, 2023, and the entire contents thereof are incorporated herein by reference.

### TECHNICAL FIELD

The present disclosure relates to the field of mobile communication technology, and more specifically, to a power save mode period negotiation method, an electronic device, and a storage medium.

### BACKGROUND

Nowadays, research on Wi-Fi technology includes topics such as Ultra High Reliability (UHR), with the vision of improving the connection reliability, reducing latency, improving manageability, increasing throughput at different signal-to-noise ratio (SNR) levels, and reducing device-level power consumption of Wireless Local Area Networks (WLAN).

It should be noted that, information disclosed in the above background portion is provided only for better understanding of the background of the present disclosure, and thus it may contain information that does not form the prior art known by those ordinary skilled in the art.

### SUMMARY

This disclosure provides a power save mode period negotiation method, an electronic device, and a storage medium.

In one aspect, the embodiments of this disclosure provide a power save mode period negotiation method applied to a first AP, and the method includes:
obtaining R-TWT SP information of a neighboring AP; and
scheduling power save mode period of the first AP under at least one link based on a manner in which the R-TWT SP information of the neighboring AP is obtained, where the power save mode period and a time indicated by the R-TWT SP information are overlapped or not overlapped.

In another aspect, the embodiments of this disclosure provide a power save mode period negotiation method applied to a neighboring AP, and the method includes:
broadcasting R-TWT SP information of the neighbor AP;
where the R-TWT SP information indicates the first AP to schedule power save mode period of the first AP under at least one link based on a manner in which the R-TWT SP information of the neighboring AP is obtained, where the power save mode period and a time indicated by the R-TWT SP information are overlapped or not overlapped.

In another aspect, the embodiments of this disclosure provide a power save mode period negotiation method applied to a second AP, and the method includes:
receiving R-TWT SP information of a neighboring AP sent by the neighboring AP of a first AP, and sharing the R-TWT SP information with the first AP;
where the R-TWT SP information indicates the first AP to schedule power save mode period of the first AP under at least one link based on a manner in which the R-TWT SP information of the neighboring AP is obtained, where the power save mode period and a time indicated by the R-TWT SP information are overlapped or not overlapped.

In another aspect, the embodiments of this disclosure provide an electronic device, which is a first AP, and the electronic device includes:
an obtaining module, configured to obtain R-TWT SP information of a neighboring AP; and a scheduling module, configured to schedule power save mode period of the first AP under at least one link based on a manner in which the R-TWT SP information of the neighboring AP is obtained, where the power save mode period and a time indicated by the R-TWT SP information are overlapped or not overlapped.

In another aspect, the embodiments of this disclosure provide an electronic device, which is a neighboring AP, and the electronic device includes:
a broadcasting module, configured to broadcast R-TWT SP information of the neighbor AP; where the R-TWT SP information indicates the first AP to schedule power save mode period of the first AP under at least one link based on a manner in which the R-TWT SP information of the neighboring AP is obtained, where the power save mode period and a time indicated by the R-TWT SP information are overlapped or not overlapped.

In another aspect, the embodiments of this disclosure provide an electronic device, which is a second AP, and the electronic device includes:
a sharing module, configured to receive R-TWT SP information of a neighboring AP sent by the neighboring AP of a first AP, and share the R-TWT SP information with the first AP;
   where the R-TWT SP information indicates the first AP to schedule power save mode period of the first AP under at least one link based on a manner in which the R-TWT SP information of the neighboring AP is obtained, where the power save mode period and a time indicated by the R-TWT SP information are overlapped or not overlapped.

The embodiments of this disclosure further provide an electronic device, including a memory, a processor, and a computer program stored in the memory and executable on the processor, where the processor executes the program to implement one or more of the methods according to the embodiments of this disclosure.

The embodiments of this disclosure further provide a computer-readable storage medium storing a computer program that, when executed by a processor, implements one or more of the methods according to the embodiments of this disclosure.

Additional aspects and advantages of embodiments of this disclosure will be set forth in part in the description which follows, and will become apparent from the description or may be learned by practice of this disclosure.

### BRIEF DESCRIPTION OF THE DRAWINGS

To more clearly illustrate the technical solutions of the embodiments of this disclosure, the accompanying drawings used in the description of the embodiments of this disclosure will be briefly introduced below. Obviously, the accompanying drawings described below are only some embodiments of this disclosure. For those skilled in the art, other drawings can be obtained based on these drawings without creative effort.

FIG. 1 is a schematic diagram of a first example of an embodiment of this disclosure;

FIG. 2 is a first flowchart of the power save mode period negotiation method provided in an embodiment of this disclosure;

FIG. 3 is a second flowchart of the power save mode period negotiation method provided in an embodiment of this disclosure;

FIG. 4 is a third flowchart of the power save mode period negotiation method provided in an embodiment of this disclosure;

FIG. 5 is a first schematic diagram of the structure of an electronic device provided in an embodiment of this disclosure;

FIG. 6 is a second schematic diagram of the structure of an electronic device provided in an embodiment of this disclosure;

FIG. 7 is a third schematic diagram of the structure of an electronic device provided in an embodiment of this disclosure; and

FIG. 8 is a fourth schematic diagram of the structure of an electronic device provided in an embodiment of this disclosure.

### DETAILED DESCRIPTION

Exemplary embodiments will now be described in detail, examples of which are illustrated in the accompanying drawings. Unless otherwise indicated, the same numerals in different drawings denote the same or similar elements in the following description relating to the drawings. The embodiments described in the following exemplary embodiments do not represent all embodiments consistent with the present invention. Rather, they are merely examples of apparatuses and methods consistent with some aspects of the invention as detailed in the appended claims.

In this disclosure, the terminology used is for the purpose of describing particular embodiments only and is not intended to be limiting of the disclosure. The singular forms “a”, “the”, and “said” used in this disclosure and the appended claims are also intended to include the plural forms unless the context clearly indicates otherwise. It should also be understood that the term “and/or” as used herein refers to and includes any or all possible combinations of one or more associated listed items. For example, A and/or B can represent: A alone, A and B together, and B alone. The character “/” generally indicates that the preceding and following objects are in an “or” relationship. The term “multiple” refers to two or more; therefore, in this disclosure, “multiple” may also be understood as “at least two”.

It should be understood that although the terms first, second, third, etc., may be used in this disclosure to describe various information, such information should not be limited to these terms. These terms are used only to distinguish information of the same type from one another. For example, without departing from the scope of this disclosure, first information may also be referred to as second information, and similarly, second information may also be referred to as first information. Depending on the context, for example, the word “if” as used herein may be interpreted as “when”, “while” or “in response to determining”.

Hereinafter, the technical solutions of the embodiments of this disclosure will be clearly and completely described with reference to the accompanying drawings. Obviously, the described embodiments are only some embodiments of this disclosure, and not all embodiments. Based on the embodiments of this disclosure, all other embodiments obtained by those of ordinary skill in the art without creative effort are within the scope of protection of this disclosure.

This disclosure provides a power save mode period negotiation method, an electronic device, and a storage medium to provide a mechanism for supporting power saving of AP (Access Point).

The method and device are based on the same concept of the application. Since the method and device solve problems in similar ways, the implementation of the device and method can refer to each other, and the repeated parts will be omitted.

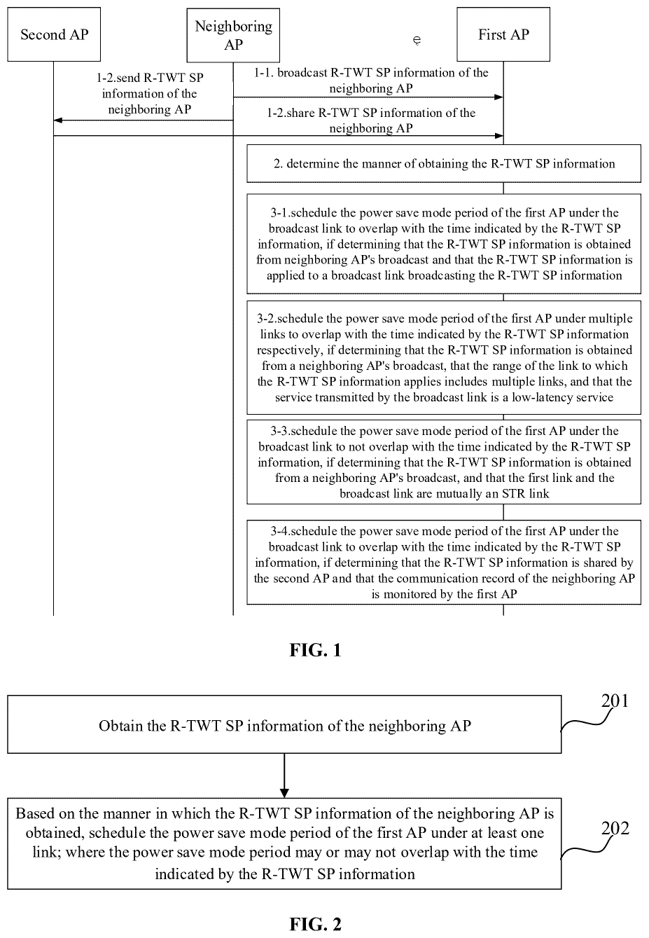

As a first example, referring to FIG. 1, which illustrates an application scenario example of the power save mode period negotiation method provided by various embodiments of this disclosure. In this example, the first AP obtains the R-TWT SP of its neighboring AP, and the obtaining manner includes either step 1-1 or step 1-2.

In the embodiment of this disclosure, a neighboring AP is, for example, an AP that is logically close to the first AP, e.g., an AP that the first AP receives a stronger signal from, or an AP that is physically close to the first AP, or an AP that belongs to the same basic service set (BSS) as the first AP. In a WLAN, an AP can discover a neighboring AP by obtaining the basic service set identifier (BSSID) sent by another AP through channel probing. The neighboring AP can be recommended as better roaming targets to the STA. Furthermore, when adjusting RF parameters, considering the neighboring AP allows for full utilization of spectrum resources and enables load balancing among multiple APs.

Step 1-1: The neighboring AP of the first AP broadcast its own R-TWT SP information, where R-TWT stands for Restricted Target Wake Time, SP stands for Service Period, and R-TWT SP strands for Restricted Target Wake Time Service Period;
Or

Step 1-2: The neighboring AP sends the R-TWT SP information to the second AP, instructing the second AP to share the R-TWT SP information with the first AP.

In this embodiment of the disclosure, unless otherwise specified, the neighboring AP refers to a neighboring AP of the first AP; in special cases, for example, if the neighboring AP is called AP-1, then the second AP can be any AP other than the first AP among the neighboring APs of AP-1.

Optionally, this embodiment of the disclosure does not limit the execution order of 1-1 and 1-2.

Step 2: The first AP obtains the R-TWT SP information of the neighboring AP through any of the above manners, and determines the manner in which the R-TWT SP information is obtained.

Step 3: Based on the manner for obtaining the R-TWT SP information, the power save mode period of the first AP under at least one link is scheduled. Specifically:
Step 3-1: When the first AP determines that the R-TWT SP information is obtained from a neighboring AP's broadcast, and that the R-TWT SP information is applied to a broadcast link broadcasting the R-TWT SP information, the power save mode period of the first AP under the broadcast link is scheduled to overlap with the time indicated by the R-TWT SP information. Specifically, when the R-TWT SP information is applied to the aforementioned broadcast link, that is, within the time indicated by the R-TWT SP information, the neighboring AP can transmit low-latency service data under the broadcast link.

Within the time indicated by the R-TWT SP information, the power save mode period of the first AP under the broadcast link is scheduled to overlap with the time indicated by the R-TWT SP information. That is, the first AP sleeps within the R-TWT SP under the broadcast link, avoiding interference with the service data transmission of the neighboring AP under the broadcast link caused by the first AP communicating within the time indicated by the R-TWT SP information.

It is understood that in the embodiments of this disclosure, the power save mode period of the first AP under the broadcast link overlapping with the time indicated by the R-TWT SP information, may include the case where the power save mode period and the time of the R-TWT SP partially or completely overlap; the embodiments of this disclosure do not limit this.

Step 3-2: When the first AP determines that the R-TWT SP information is obtained from the broadcast of the neighboring AP, and the range of the link to which the R-TWT SP information applies includes multiple links, and the service transmitted by the broadcast link is a low-latency service, the power save mode period of the first AP under the multiple links is scheduled to overlap with the time indicated by the R-TWT SP information.

Similarly, within the time indicated by the R-TWT SP information, the power save mode period of the first AP under the broadcast link is scheduled to overlap with the time indicated by the R-TWT SP information. That is, the first AP sleeps within the R-TWT SP under the broadcast link, avoiding interference with the service data transmission of the neighboring AP under the broadcast link caused by the first AP communicating within the time indicated by the R-TWT SP information. This ensures the transmission of low-latency service data and avoids the transmission delay of low-latency service data caused by network congestion.

Step 3-3: When the first AP determines that the R-TWT SP information is obtained from the neighboring AP's broadcast, and that the first link and the broadcast link are mutually an STR (Simultaneous Transmitting and Receiving) link pair, then the first AP's power save mode period under the first link is scheduled to not overlap with the time indicated by the R-TWT SP information. The first link and the broadcast link being mutually an STR link pair, meaning that service data can be sent and received synchronously under both the first link and the broadcast link. In other words, the service data transmission of the first AP under the first link will not interfere with the service data transmission of the neighboring AP under the broadcast link.

In this way, within the time indicated by the R-TWT SP information, the scheduled power save mode period of the first AP under the first link does not overlap with the time indicated by the R-TWT SP information. That is, the first AP does not need to sleep within the time indicated by the R-TWT SP information and can communicate normally without interfering with the service data transmission of neighboring AP under the broadcast link. Therefore, in this embodiment of the present disclosure, when the first link and the broadcast link are mutually an STR link pair, the power save mode period of the first AP under the first link can be scheduled to not overlap with the time indicated by the R-TWT SP information. This ensures both the service data transmission of neighboring AP under the broadcast link and the communication of the STR link pair, improving data transmission efficiency and spectrum utilization.

It is understood that in this embodiment of the disclosure, the power save mode period of the first AP under the broadcast link being not overlapped with the time indicated by the R-TWT SP information, may include the case where the power save mode period and the time of the R-TWT SP do not overlap completely or partially; this embodiment of the disclosure does not limit this.

Optionally, the Broadcast TWT Parameter Set field of the R-TWT SP information may include first identification information, which identifies the range of links to which the R-TWT SP information applies; where, the first identification information indicates that the range of links to which the R-TWT SP information applies includes the aforementioned broadcast link; or the first identification information indicates that the range of links to which the R-TWT SP information applies includes the aforementioned multiple links. The TID information of the broadcast link may indicate that the service transmitted by the broadcast link is a low-latency service. Optionally, the TID information may be, for example, TID-to-link mapping information.

Steps 3-4: If the first AP determines that the R-TWT SP information is shared by the second AP and that the communication record of the neighboring AP is monitored by the first AP, then the power save mode period of the first AP under at least one link is scheduled to be overlapped with the time indicated by the R-TWT SP information, when the communication record of the neighboring AP (e.g., the communication record within the BSS where the neighboring AP resides) is monitored by the first AP, it can predict that communication may still occur within the BSS where the neighboring AP resides during the time indicated by the R-TWT SP information. By scheduling the first AP's power save mode period under at least one link to overlap with the time indicated by the R-TWT SP information, that is, during the time indicated by the R-TWT SP information, the first AP sleeps under at least one link, interference with the communication within the BSS where the neighboring AP resides is avoided.

In this way, without interfering with the data transmission of services within the time indicated by the R-TWT SP information, the power save mode period of the first AP under different links can be scheduled according to the different obtaining manners of the R-TWT SP information, so as to make reasonable use of spectrum resources, improve the utilization rate of spectrum resources, and achieve load balancing among multiple APs.

As shown in FIG. 2, this embodiment of the present disclosure provides a power save mode period negotiation method. Optionally, the method can be applied to a first access point device. Optionally, in this embodiment of the present disclosure, the first AP is, for example, a device with wireless-to-wired bridging function, and the first AP is responsible for extending the services provided by the wired network to the wireless network.

The method may include the following steps:
Step 201: Obtain the R-TWT SP information of the neighboring AP;
Step 202: Based on the manner in which the R-TWT SP information of the neighboring AP is obtained, schedule the power save mode period of the first AP under at least one link; where the power save mode period may or may not overlap with the time indicated by the R-TWT SP information.

Typically, an AP can come in three forms, such as a soft AP (or soft AP MLD), a Non-Simultaneous Transmitting and Receiving (NSTR) mobile AP (or NSTR mobile AP MLD; the mobile AP refers to a mobile AP; AP MLD refers to an Access Point Multi-Link Device), and a regular AP (or regular AP MLD; the regular AP refers to a standard AP), where a regular AP is for example a router. Taking the soft AP and the NSTR mobile AP as examples, they are typically battery-powered, have high power consumption, and their communication with the STA is usually not in a long-term continuous state. Therefore, a mechanism to support AP power saving is needed. In this embodiment of the disclosure, taking the scheduling of the power save mode period of the first AP under at least one link as an example, a mechanism to support AP power saving is provided.

The R-TWT SP information may include the transmission time parameter of the neighboring AP (i.e., the time indicated by the R-TWT SP information, which is the time period during which the neighboring AP and its associated AP transmit service data), and may also include other information of the neighboring AP, such as the Broadcast TWT Parameter Set field, which is not limited herein.

In this embodiment of the disclosure, the first AP obtains the R-TWT SP information of the neighboring AP. This R-TWT SP information can be broadcast by the neighboring AP or shared by the second AP, and there is no limitation thereto. That is, the manner for obtaining the R-TWT SP information can include: receiving the R-TWT SP information broadcast by the neighboring AP, receiving the R-TWT SP information of the neighboring AP shared by the second AP, etc.

In this embodiment of the disclosure, unless otherwise specified, a neighboring AP refers to a neighboring AP of the first AP; in special cases, for example, if a neighboring AP is called AP-1, then the second AP can be any AP other than the first AP among the neighboring APs of AP-1.

Optionally, the neighboring AP and the second AP can be subordinate APs of the same or different AP MLDs, or they can be different AP MLDs or independent APs; there are no restrictions here. Optionally, the neighboring AP is subordinate to the first AP MLD, and the second AP is subordinate to the second AP MLD. The second AP can be within a certain location range or coverage area of the neighboring AP, so that the second AP can obtain the parameter information of the neighboring AP. For example, the second AP can obtain the R-TWT SP information of the neighboring AP.

Any two APs can transmit data via beacon frames or probe response frames. The probe response frame can be an unsolicited probe response frame.

The first AP's power save mode period (i.e., sleep time period) under at least one link is scheduled based on the manner for obtaining the R-TWT SP information; where the power save mode period may or may not overlap with the time indicated by the R-TWT SP information.

At least one link includes a link between the first AP and a STA, or a link between the first AP and multiple STAs (i.e., the first AP is an Access Point Multi-Link Device (AP MLD)).

If the first AP is a multi-link access point device, the power save mode periods of the first AP under each Link can be independent of each other. For example, if at least one link can include Link 1, Link 2 and Link 3, and the power save mode period of the first AP under Link 1 is time period 1, then during time period 1, the first AP is in a sleep state under Link 1. However, under Link 2 or Link 3, if the current time is not in the power save mode period of Link 2 or Link 3, the first AP can remain awake to maintain service data transmission.

Optionally, the power save mode period of the first AP under at least one link is overlapped or not overlapped with the time indicated by the R-TWT SP information, that is, whether the power save mode period of the first AP under at least one link is the same as the time indicated by the R-TWT SP information. For example, if the time indicated by the R-TWT SP information includes time period 1, and the power save mode period of the first AP under Link 3 includes time period 2, then if the power save mode period of the first AP under Link 1 overlaps with the time indicated by the R-TWT SP information, then time period 2 is the same as time period 1; if the power save mode period of the first AP under Link 1 does not overlap with the time indicated by the R-TWT SP information, that is, time period 2 and time period 1 are different, and there is no overlap between the two time periods.

When the first AP is scheduling the power save mode period of the first AP under each link, it can first determine whether the first AP's data transmission under that link conflicts with the neighboring AP's data transmission within the time indicated by the R-TWT SP information. Based on whether a conflict exists, the power save mode period of the first AP under that link is then scheduled. Specifically, if there is no conflict, the first AP can schedule its power save mode period under that link to not overlap with the time indicated by the R-TWT SP information; that is, within the time indicated by the R-TWT SP information, both the first AP and the neighboring AP can transmit service data under that link. If a conflict exists, the first AP can schedule its power save mode period under that link to overlap with the time indicated by the R-TWT SP information; that is, within the time indicated by the R-TWT SP information, the first AP can sleep under that link, while the neighboring AP can transmit service data. This avoids the first AP from communicating and interfering with the service data transmission of the neighboring AP when the neighboring AP is transmitting service data under this link. In this way, the power save mode period of the first AP under different links can be rationally scheduled without interfering with data transmission within the time indicated by the R-TWT SP information, providing a mechanism to support AP power saving.

Optionally, in this embodiment of the disclosure, the method for obtaining the R-TWT SP information includes manner one or manner two:
Manner 1: Receive the R-TWT SP information broadcast by the neighboring AP;
Manner 2: Receive the R-TWT SP information shared by the neighboring AP from the second AP.

Receiving the R-TWT SP information broadcast by the neighboring AP, means that the first AP can directly obtain the R-TWT SP information broadcast by the neighboring AP.

In manner 2, receiving the R-TWT SP information shared by the second AP, means that the first AP can obtain the R-TWT SP information of the neighboring AP through the forwarding operation of the second AP. Service data can be transmitted between the neighboring AP and the second AP. Optionally, if the first AP and the neighboring AP cannot listen to each other, the first AP can obtain the R-TWT SP information of the neighboring AP by receiving the R-TWT SP information shared by the second AP.

In this embodiment of the disclosure, the first AP can obtain the R-TWT SP information of the neighboring AP through any one of the above manners, or it can obtain the R-TWT SP information of the neighboring AP through both manners at the same time, depending on the actual situation.

Optionally, in this embodiment of the disclosure, the scheduling the power save mode period of the first AP under at least one link based on the manner of obtaining the R-TWT SP information of the neighboring AP, includes:
scheduling the power save mode period of the first AP under at least one link to overlap with the time indicated by the R-TWT SP information, where the R-TWT SP information is obtained from the broadcast of the neighboring AP.

The scheduling of the power save mode period of the first AP under at least one link includes:
a Broadcast TWT Parameter Set field of the R-TWT SP information including first identification information, which indicates the range of the link to which the R-TWT SP information is applied;
scheduling the power save mode period of the first AP under the broadcast link; where, the first identification information indicates that the range of the applied link includes: the broadcast link of the broadcast R-TWT SP information;
or
scheduling the power save mode period of the first AP under multiple links; where, the first identification information indicates that the range of the applied link includes the multiple links, and the TID information of the broadcast link indicates that the service transmitted by the broadcast link is a low-latency service.

A broadcast link is a link that broadcasts R-TWT SP information. For example, when the first AP receives R-TWT SP information broadcast by the neighboring AP, the link between the first AP and the second AP is the broadcast link.

As an example, the format of the Broadcast TWT Parameter Set field can be shown in Table 1 below:

TABLE 1

| | | | Nominal | TWT | | Restricted |
|---|---|---|---|---|---|---|
| | | Target | Minimum | Wake | | TWT Traffic |
| Information | Request | Wake | TWT Wake | Interval | Broadcast | Info |
| content | Type | Time | Duration | Mantissa | TWT Info | (optional) |
| Number of | 2 | 2 | 1 | 2 | 2 | 0 or 3 |
| bytes (Octets) | | | | | | |

The Request Type field of the Broadcast TWT Parameter Set field can be shown in Table 2 below:

TABLE 2

| | | | | Last | | | TWT | |
|---|---|---|---|---|---|---|---|---|
| | | TWT | | Broadcast | | Broadcast | Wake | |
| | TWT | Setup | Trigger | Parameter | Flow | TWT | Interval | |
| content | Request | Command | frame | Set | Type | Recommendation | Exponent | Aligned |
| Bits | 1 | 2 | 1 | 1 | 1 | 2 | 2 | 1 |
| Bits | B0 | B1 to | B4 | B5 | B6 | B7 to | B10 to | B15 |
| order | | B3 | | | | B9 | B14 | |

For example, the “Aligned” subfield of the Request Type field in the Broadcast TWT Parameter Set field can be used. Setting the “Aligned” subfield to different values serves as the first identification information, indicating the range of links to which the R-TWT SP information is applied. For instance, when the “Aligned” subfield is set to the value 0, the first identification information indicates that the range of links to which the R-TWT SP information is applied includes the broadcast link of the broadcast R-TWT SP information; when the “Aligned” subfield is set to the value 1, the range of links to which the R-TWT SP information is applied includes multiple links.

In this embodiment of the disclosure, the TID information can be, for example, TID-to-link mapping information. Optionally, a subfield in the Restricted TWT Traffic Info field that is associated with the TID-to-link mapping information can be used as the TID-to-link mapping information.

The format of the Restricted TWT Traffic Info field can be shown in Table 3 below:

TABLE 3

| | Traffic | Restricted | Restricted |
|---|---|---|---|
| Information | Info | TWT DL TID | TWT UL TID |
| content | Control | Bitmap | Bitmap |
| Number of bytes | 1 | 1 | 1 |
| (Octets) | | | |

For example, the Restricted TWT DL TID Bitmap subfield and/or the Restricted TWT UL TID Bitmap in the Restricted TWT Traffic Info field can be used. The Restricted TWT DL TID Bitmap subfield and the Restricted TWT UL TID Bitmap subfield are set to different values to serve as TID-to-link mapping information. For example, when the Restricted TWT DL TID Bitmap subfield is set to the first value, it indicates that the downlink transmission service carried by the broadcast link is a low-latency service. When the Restricted TWT UL TID Bitmap subfield is set to the second value, it indicates that the uplink transmission service transmitted by the broadcast link is a low-latency service.

In this embodiment of the disclosure, when the range of the link to which the R-TWT SP information is applied includes the aforementioned broadcast link, that is, during the time indicated by the R-TWT SP information, the neighboring AP performs service data transmission under the broadcast link. By scheduling the power save mode period of the first AP under the broadcast link to overlap with the time indicated by the R-TWT SP information, that is, the first AP sleeps under the broadcast link, it is avoided that when the neighboring AP performs service data transmission under the broadcast link, the first AP communicates and interferes with the service data transmission performed by the neighboring AP.

When the first identification information indicates that the range of the link to which the R-TWT SP information is applied includes multiple links, and the TID information indicates that the service transmitted by the broadcast link is a low-latency service, the power save mode period of the first AP under multiple links is scheduled to overlap with the time indicated by the R-TWT SP information. That is, the first AP sleeps under the broadcast link, which avoids the first AP from communicating and interfering with the service data transmission of the neighboring AP when the neighboring AP is transmitting service data under this broadcast link, thus ensuring the transmission of low-latency service data and avoiding the transmission delay of low-latency service data caused by network congestion.

Optionally, in this embodiment of the disclosure, the power save mode period of the first AP under the first link is scheduled to not overlap with the time indicated by the R-TWT SP information, where the first link and the broadcast link are mutually an STR link pair.

When the first link and the broadcast link are mutually an STR link pair, meaning that service data can be sent and received synchronously under the first link and the broadcast link. In other words, service data transmission under the first link will not interfere with service data transmission under the broadcast link.

Furthermore, within the time indicated by the R-TWT SP information, the data transmission of services under the first link will not interfere with the data transmission of services under the broadcast link. The power save mode period of the first AP under the first link can be scheduled to not overlap with the time indicated by the R-TWT SP information, so as to reasonably schedule the power save mode period of the first AP under the first link without interfering with the data transmission of services within the time indicated by the R-TWT SP information.

Optionally, in this embodiment of the disclosure, the scheduling the power save mode period of the first AP under at least one link based on the manner of obtaining the R-TWT SP information of the neighboring AP includes:
scheduling the power save mode period of the first AP under at least one link to overlap with the time indicated by the R-TWT SP information, where the R-TWT SP information is shared by the second AP, and the communication record of the neighboring AP is monitored by the first AP.

The first AP can monitor the communication record of the neighboring AP by using information reported by the STA associated therewith under any of the at least one link. Specifically, the STA associated with the first AP under any link can report the information to the AP1 in the case where the communication of other BSSs (e.g., the BSS where the neighboring AP is located; where BSS stands for Basic Service Set) is collected. The reported information may include BSSID information and BSS color information of the other BSS collected by the STA, such as BSSID information and BSS color information of the BSS where the neighboring AP is located.

When the first AP detects the communication record of a neighboring AP, it can predict that communication may still occur within the BSS where the neighboring AP is located within the time indicated by the R-TWT SP information. By scheduling the power save mode period of the first AP under at least one link to overlap with the time indicated by the R-TWT SP information, that is, within the time indicated by the R-TWT SP information, the first AP is in sleep mode under at least one link, while communication can still occur within the BSS where the neighboring AP is located. This can prevent the first AP from interfering with communication within the BSS where the neighboring AP is located during the time indicated by the R-TWT SP information. For example, if the at least one link includes Link 4, and the R-TWT SP information is shared by the second AP, and the communication record of the neighboring AP is monitored at the STA associated with the first AP under Link 4, then the power save mode period of the first AP under Link 4 can be scheduled to overlap with the time indicated by the R-TWT SP information.

In this embodiment of the disclosure, the first AP obtains the R-TWT SP information of its neighboring APs and schedules the power save mode period of the first AP under at least one link according to the manner of obtaining the R-TWT SP information; where, the power save mode period may or may not overlap with the time indicated by the R-TWT SP information; thus, without interfering with the data transmission of services within the time indicated by the R-TWT SP information, the power save mode period of the first AP under different links can be scheduled according to different manners of obtaining the R-TWT SP information. This embodiment of the disclosure provides a mechanism to support AP power saving.

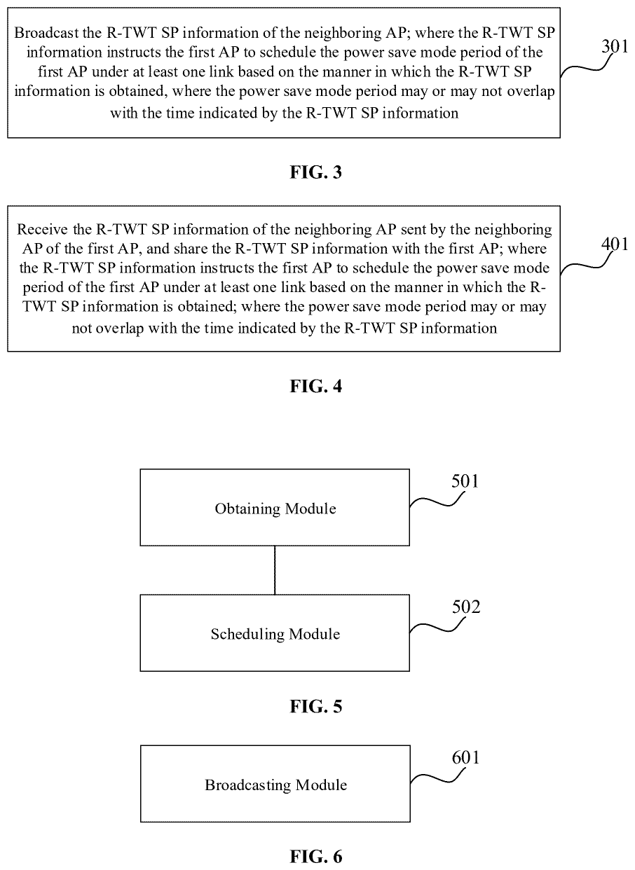

Referring to FIG. 3, this disclosure also provides a sleep mechanism negotiation method applied to a neighboring AP. The method may include the following steps:
Step 301: Broadcast the R-TWT SP information of the neighboring AP.

The R-TWT SP information instructs the first AP to schedule the power save mode period of the first AP under at least one link based on the manner in which the R-TWT SP information is obtained, where the power save mode period may or may not overlap with the time indicated by the R-TWT SP information.

Typically, an AP can come in three forms, such as a soft AP (or soft AP MLD), a NSTR mobile AP (or NSTR mobile AP MLD; the mobile AP refers to a mobile AP; AP MLD refers to an Access Point Multi-Link Device), and a regular AP (or regular AP MLD; the regular AP refers to a standard AP), where a regular AP is for example a router. Taking the soft AP and the NSTR mobile AP as examples, they are typically battery-powered, have high power consumption, and their communication with the STA is usually not in a long-term continuous state. Therefore, a mechanism to support AP power saving is needed. In this embodiment of the disclosure, taking the indicating the first AP to schedule the power save mode period of the first AP under at least one link as an example, a mechanism to support AP power saving is provided.

The R-TWT SP information may include the transmission time parameter of the neighboring AP (i.e., the time indicated by the R-TWT SP information, which is the time period during which the neighboring AP and its associated AP transmit service data), and may also include other information of the neighboring AP, such as the Broadcast TWT Parameter Set field, which is not limited herein.

The R-TWT SP information of the neighboring AP is broadcast by the neighboring AP, and the first AP can directly obtain the R-TWT SP information broadcast by the neighboring AP.

In this embodiment of the disclosure, the neighboring AP can also instruct the second AP to share the R-TWT SP information with the first AP by sending the R-TWT SP information to the second AP. Optionally, if the neighboring AP and the first AP cannot listen to each other, the neighboring AP can instruct the second AP to share the R-TWT SP information with the first AP by sending the R-TWT SP information to the second AP, thereby enabling the first AP to obtain the neighboring AP's R-TWT SP information. That is, the first AP can obtain the neighboring AP's R-TWT SP information in the following ways: receiving the R-TWT SP information broadcast by the neighboring AP, receiving the R-TWT SP information of the neighboring AP shared by the second AP, etc.

In this embodiment of the disclosure, unless otherwise specified, a neighboring AP refers to a neighboring AP of the first AP; in special cases, for example, if a neighboring AP is called AP-1, then the second AP can be any AP other than the first AP among the neighboring APs of AP-1.

Optionally, the neighboring AP and the second AP can be subordinate APs of the same or different AP MLDs, or they can be different AP MLDs or independent APs; there are no restrictions here. Optionally, the neighboring AP is subordinate to the first AP MLD, and the second AP is subordinate to the second AP MLD. The second AP can be within a certain location range or coverage area of the neighboring AP, so that the second AP can obtain the parameter information of the neighboring AP. For example, the second AP can obtain the R-TWT SP information of the neighboring AP.

The first AP's power save mode period (i.e., sleep time period) under at least one link is scheduled based on the manner for obtaining the R-TWT SP information; where the power save mode period may or may not overlap with the time indicated by the R-TWT SP information.

At least one link includes a link between the first AP and a STA, or a link between the first AP and multiple STAs (i.e., the first AP is an Access Point Multi-Link Device (AP MLD)). If the first AP is a multi-link access point device, the power save mode periods of the first AP under each Link can be independent of each other. For example, if at least one link can include Link 1, Link 2 and Link 3, and the power save mode period of the first AP under Link 1 is time period 1, then during time period 1, the first AP is in a sleep state under Link 1. However, under Link 2 or Link 3, if the current time is not in the power save mode period of Link 2 or Link 3, the first AP can remain awake to maintain service data transmission.

Optionally, the power save mode period of the first AP under at least one link is overlapped or not overlapped with the time indicated by the R-TWT SP information, that is, whether the power save mode period of the first AP under at least one link is the same as the time indicated by the R-TWT SP information. For example, if the time indicated by the R-TWT SP information includes time period 1, and the power save mode period of the first AP under Link 3 includes time period 2, then if the power save mode period of the first AP under Link 1 overlaps with the time indicated by the R-TWT SP information, then time period 2 is the same as time period 1; if the power save mode period of the first AP under Link 1 does not overlap with the time indicated by the R-TWT SP information, that is, time period 2 and time period 1 are different, and there is no overlap between the two time periods.

When indicating the first AP to schedule the power save mode period of the first AP under each link, it can first determine whether the first AP's data transmission under that link conflicts with the neighboring AP's data transmission within the time indicated by the R-TWT SP information. Based on whether a conflict exists, the first AP is then instructed to schedule the power save mode period of the first AP under that link. Specifically, if there is no conflict, the first AP can be instructed to schedule its power save mode period under that link to not overlap with the time indicated by the R-TWT SP information; that is, within the time indicated by the R-TWT SP information, both the first AP and the neighboring AP can transmit service data under that link. If a conflict exists, the first AP can be instructed to schedule its power save mode period under that link to overlap with the time indicated by the R-TWT SP information; that is, within the time indicated by the R-TWT SP information, the first AP can sleep under that link, while the neighboring AP can transmit service data. This avoids the first AP from communicating and interfering with the service data transmission of the neighboring AP when the neighboring AP is transmitting service data under this link. In this way, the first AP can be rationally instructed to schedule the power save mode period of the first AP under different links without interfering with data transmission within the time indicated by the R-TWT SP information, providing a mechanism to support AP power saving.

Optionally, in this embodiment of the disclosure, a Broadcast TWT Parameter Set field of the R-TWT SP information including first identification information, which indicates the range of the link to which the R-TWT SP information is applied;
The R-TWT SP information indicates the first AP to: schedule the power save mode period of the first AP under the broadcast link to be overlapped with the time indicated by the R-TWT SP information; where, the first identification information indicates that the range of the applied link includes: the broadcast link of the broadcast R-TWT SP information;
or
The R-TWT SP information indicates the first AP to: schedule the power save mode period of the first AP under multiple links to be overlapped with the time indicated by the R-TWT SP information; where, the first identification information indicates that the range of the applied link includes the multiple links, and the TID information of the broadcast link indicates that the service transmitted by the broadcast link is a low-latency service.

A broadcast link is a link that broadcasts R-TWT SP information. For example, when the first AP receives R-TWT SP information broadcast by the neighboring AP, the link between the first AP and the second AP is the broadcast link.

As an example, the format of the Broadcast TWT Parameter Set field can be shown in Table 1 above; the Request Type field of the Broadcast TWT Parameter Set field can be shown in Table 2 above. For example, the “Aligned” subfield of the Request Type field in the Broadcast TWT Parameter Set field can be used. Setting the “Aligned” subfield to different values serves as the first identification information, indicating the range of links to which the R-TWT SP information is applied. For instance, when the “Aligned” subfield is set to the value 0, the first identification information indicates that the range of links to which the R-TWT SP information is applied includes the broadcast link of the broadcast R-TWT SP information; when the “Aligned” subfield is set to the value 1, the range of links to which the R-TWT SP information is applied includes multiple links.

In this embodiment of the disclosure, the TID information can be, for example, TID-to-link mapping information. Optionally, a subfield in the Restricted TWT Traffic Info field that is associated with the TID-to-link mapping information can be used as the TID-to-link mapping information.

The format of the Restricted TWT Traffic Info field can be shown in Table 3 above. For example, the Restricted TWT DL TID Bitmap subfield and/or the Restricted TWT UL TID Bitmap in the Restricted TWT Traffic Info field can be used. The Restricted TWT DL TID Bitmap subfield and the Restricted TWT UL TID Bitmap subfield are set to different values to serve as TID-to-link mapping information. For example, when the Restricted TWT DL TID Bitmap subfield is set to the first value, it indicates that the downlink transmission service carried by the broadcast link is a low-latency service. When the Restricted TWT UL TID Bitmap subfield is set to the second value, it indicates that the uplink transmission service transmitted by the broadcast link is a low-latency service.

In this embodiment of the disclosure, when the range of the link to which the R-TWT SP information is applied includes the aforementioned broadcast link, that is, during the time indicated by the R-TWT SP information, the neighboring AP performs service data transmission under the broadcast link. By instructing the first AP to schedule the power save mode period of the first AP under the broadcast link to overlap with the time indicated by the R-TWT SP information, that is, the first AP sleeps under the broadcast link, it is avoided that when the neighboring AP performs service data transmission under the broadcast link, the first AP communicates and interferes with the service data transmission performed by the neighboring AP.

When the first identification information indicates that the range of the link to which the R-TWT SP information is applied includes multiple links, and the TID information indicates that the service transmitted by the broadcast link is a low-latency service, the first AP is instructed to schedule the power save mode period of the first AP under multiple links to overlap with the time indicated by the R-TWT SP information. That is, the first AP sleeps under the broadcast link, which avoids the first AP from communicating and interfering with the service data transmission of the neighboring AP when the neighboring AP is transmitting service data under this broadcast link, thus ensuring the transmission of low-latency service data and avoiding the transmission delay of low-latency service data caused by network congestion.

Optionally, in this embodiment of the disclosure, the R-TWT SP information indicates the first AP to: schedule the power save mode period of the first AP under the first link to not overlap with the time indicated by the R-TWT SP information, where the first link and the broadcast link are mutually an STR link pair.

When the first link and the broadcast link are mutually an STR link pair, meaning that service data can be sent and received synchronously under the first link and the broadcast link. In other words, service data transmission under the first link will not interfere with service data transmission under the broadcast link.

Furthermore, within the time indicated by the R-TWT SP information, the data transmission of services under the first link will not interfere with the data transmission of services under the broadcast link. The first AP can be instructed to schedule the power save mode period of the first AP under the first link to not overlap with the time indicated by the R-TWT SP information, so as to reasonably schedule the power save mode period of the first AP under the first link without interfering with the data transmission of services within the time indicated by the R-TWT SP information.

Optionally, the embodiment of this disclosure may further include the following steps:
sending the R-TWT SP information to the second AP, instructing the second AP to share the R-TWT SP information with the first AP.

Optionally, the neighboring AP can enable the first AP to obtain the R-TWT SP information by directly broadcasting its R-TWT SP information Alternatively, it can send the R-TWT SP information to a second AP, instructing the second AP to forward the R-TWT SP information to the first AP, thus ensuring the first AP can acquire the R-TWT SP information. For example, if the first AP and the neighboring AP cannot listen to each other, the neighboring AP can forward the R-TWT SP information to the first AP, allowing the first AP to obtain the neighboring AP's R-TWT SP information.

Optionally, this disclosure does not restrict the order of operations for the neighboring AP broadcasting the neighboring AP's own R-TWT SP information and the sending of R-TWT SP information to the second AP.

By sending R-TWT SP information to the second AP, instructing the second AP to share the R-TWT SP information with the first AP, the ways in which the first AP obtains the R-TWT SP information of neighboring APs can be enriched.

In this embodiment of the disclosure, the neighboring AP broadcasts its own R-TWT SP information; where, the R-TWT SP information instructs the first AP to schedule the power save mode period of the first AP under at least one link according to the manner of obtaining the R-TWT SP information; where, the power save mode period may or may not overlap with the time indicated by the R-TWT SP information; thus, in this way, the first AP can directly obtain the R-TWT SP information of the neighboring AP through the broadcast of the neighboring AP, and without interfering with the data transmission of services within the time indicated by the R-TWT SP information, the first AP can schedule the power save mode period under different links according to the different obtaining manners of the R-TWT SP information. This disclosure embodiment provides a mechanism to support AP power saving.

Referring to FIG. 4, the embodiment of this disclosure also provides a power save mode period negotiation method applied to a second AP, the method including the following steps:
Step 401: Receive the R-TWT SP information of the neighboring AP sent by the neighboring AP of the first AP, and share the R-TWT SP information with the first AP.

The R-TWT SP information instructs the first AP to schedule the power save mode period of the first AP under at least one link based on the manner in which the R-TWT SP information is obtained; where the power save mode period may or may not overlap with the time indicated by the R-TWT SP information.

Typically, an AP can come in three forms, such as a soft AP (or soft AP MLD), a Non-Simultaneous Transmitting and Receiving (NSTR) mobile AP (or NSTR mobile AP MLD), and a regular AP (or regular AP MLD), where a regular AP is for example a router. Taking the soft AP and the NSTR mobile AP as examples, they are typically battery-powered, have high power consumption, and their communication with the STA is usually not in a long-term continuous state. Therefore, a mechanism to support AP power saving is needed. In this embodiment of the disclosure, taking the scheduling the power save mode period of the first AP under at least one link as an example, a mechanism to support AP power saving is provided.

The R-TWT SP information may include the transmission time parameter of the neighboring AP (i.e., the time indicated by the R-TWT SP information, which is the time period during which the neighboring AP and its associated AP transmit service data), and may also include other information of the neighboring AP, such as the Broadcast TWT Parameter Set field, which is not limited herein.

Optionally, the second AP can receive the R-TWT SP information sent by the neighboring AP and share the R-TWT SP information with the first AP. Optionally, if the first AP and the neighboring AP cannot listen to each other, the second AP can forward the R-TWT SP information received from the first AP's neighboring AP to the first AP, thereby enabling the first AP to obtain the R-TWT SP information of the neighboring AP.

The second AP can be an AP other than the first AP among the neighboring APs of the neighboring AP. Optionally, the neighboring AP and the second AP can be subordinate APs of the same or different AP MLDs, or they can be different AP MLDs or independent APs; there are no restrictions here. Optionally, the neighboring AP is subordinate to the first AP MLD, and the second AP is subordinate to the second AP MLD. The second AP can be within a certain location range or coverage area of the neighboring AP, so that the second AP can obtain the parameter information of the neighboring AP. For example, the second AP can obtain the R-TWT SP information of the neighboring AP.

Optionally, the first AP can also obtain the neighbor AP's R-TWT SP information by directly receiving broadcasts from neighbor APs. That is, the first AP can obtain the neighboring AP's R-TWT SP information in the following ways: receiving the R-TWT SP information broadcast by the neighboring AP, receiving the R-TWT SP information of the neighboring AP shared by the second AP, etc.

The first AP's power save mode period (i.e., sleep time period) under at least one link is scheduled based on the manner for obtaining the R-TWT SP information; where the power save mode period may or may not overlap with the time indicated by the R-TWT SP information.

At least one link includes a link between the first AP and a STA, or a link between the first AP and multiple STAs (i.e., the first AP is an Access Point Multi-Link Device (AP MLD)). If the first AP is a multi-link access point device, the power save mode periods of the first AP under each Link can be independent of each other. For example, if at least one link can include Link 1, Link 2 and Link 3, and the power save mode period of the first AP under Link 1 is time period 1, then during time period 1, the first AP is in a sleep state under Link 1. However, under Link 2 or Link 3, if the current time is not in the power save mode period of Link 2 or Link 3, the first AP can remain awake to maintain service data transmission.

Optionally, the power save mode period of the first AP under at least one link is overlapped or not overlapped with the time indicated by the R-TWT SP information, that is, whether the power save mode period of the first AP under at least one link is the same as the time indicated by the R-TWT SP information. For example, if the time indicated by the R-TWT SP information includes time period 1, and the power save mode period of the first AP under Link 3 includes time period 2, then if the power save mode period of the first AP under Link 1 overlaps with the time indicated by the R-TWT SP information, then time period 2 is the same as time period 1; if the power save mode period of the first AP under Link 1 does not overlap with the time indicated by the R-TWT SP information, that is, time period 2 and time period 1 are different, and there is no overlap between the two time periods.

When instructing the first AP to schedule the power save mode period of the first AP under each link, it can first determine whether the first AP's data transmission under that link conflicts with the neighboring AP's data transmission within the time indicated by the R-TWT SP information. Based on whether a conflict exists, the first AP is then instructed to schedule the power save mode period of the first AP under that link. Specifically, if there is no conflict, the first AP can schedule its power save mode period under that link to not overlap with the time indicated by the R-TWT SP information; that is, within the time indicated by the R-TWT SP information, the first AP can be instructed to perform service data transmission, and the neighboring AP can also perform service data transmission under that link. If a conflict exists, the first AP can be instructed to schedule its power save mode period under that link to overlap with the time indicated by the R-TWT SP information; that is, within the time indicated by the R-TWT SP information, the first AP can sleep under that link, while the neighboring AP can transmit service data. This avoids the first AP from communicating and interfering with the service data transmission of the neighboring AP when the neighboring AP is transmitting service data under this link. In this way, the first AP can be rationally instructed to schedule the power save mode period of the first AP under different links without interfering with data transmission within the time indicated by the R-TWT SP information, providing a mechanism to support AP power saving.

Referring to FIG. 5, based on the same principle as the method provided in the embodiments of this disclosure, the embodiment of this disclosure also provides an electronic device, where the electronic device 50 is a first AP, and the electronic device 50 includes:
an obtaining module 501, configured to obtain the R-TWT SP information of a neighboring AP; and
a scheduling module 502, configured to schedule the power save mode period of the first AP under at least one link based on the obtaining manner of the R-TWT SP information of the neighboring AP; where the power save mode period may or may not overlap with the time indicated by the R-TWT SP information.

The embodiment of this disclosure also provides a communication apparatus applied to a first AP, the apparatus including:
an information obtaining module, configured to obtain the R-TWT SP information of a neighboring AP; and
a power save mode period scheduling module, configured to schedule the power save mode period of the first AP under at least one link based on the obtaining manner of the e R-TWT SP information; where the power save mode period may or may not overlap with the time indicated by the R-TWT SP information

Referring to FIG. 6, the embodiment of this disclosure also provides an electronic device 60, which is a neighboring AP. The electronic device 60 includes:
a broadcasting module 601, configured to broadcast the R-TWT SP information of the neighboring AP.

The embodiment of this disclosure also provides a communication apparatus applied to a neighboring AP, the apparatus including:
an information broadcasting module, configured to broadcast the R-TWT SP information of the neighboring AP.

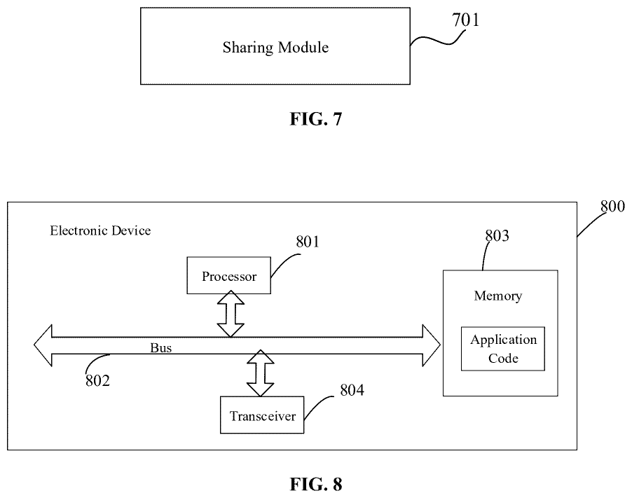

Referring to FIG. 7, the embodiment of this disclosure also provides an electronic device 70, which is a second AP. The electronic device 70 includes:
a sharing module 701, configured to receive the R-TWT SP information of the neighboring AP sent by the neighboring AP of the first AP, and share the R-TWT SP information with the first AP.

The embodiment of this disclosure also provides a communication apparatus applied to a second AP, the apparatus including:
an information sharing module, configured to receive R-TWT SP information sent by the neighboring AP of the first AP, and share the R-TWT SP information with the first AP.

The R-TWT SP information instructs the first AP to schedule the power save mode period of the first AP under at least one link based on the manner of obtaining the R-TWT SP information; where the power save mode period may or may not overlap with the time indicated by the R-TWT SP information.

In an optional embodiment, the embodiment of the present disclosure further provides an electronic device, as shown in FIG. 8, the electronic device 800 shown in FIG. 8 may be a server, including: a processor 801 and a memory 803. The processor 801 and the memory 803 are connected, e.g., through a bus 802. Optionally, the electronic device 800 may further include a transceiver 804. It should be noted that in actual applications, the transceiver 804 is not limited to one, and the structure of the electronic device 800 does not constitute a limitation on the embodiment of the present disclosure.

The processor 801 may be a CPU (Central Processing Unit), a general-purpose processor, a DSP (Digital Signal Processor), an ASIC (Application Specific Integrated Circuit), an FPGA (Field Programmable Gate Array) or other programmable logic devices, transistor logic devices, hardware components or any combination thereof. It may implement or execute various exemplary logic blocks, modules and circuits described in conjunction with the disclosure of the present invention. The processor 801 may also be a combination that implements computing functions, such as a combination of one or more microprocessors, a combination of a DSP and a microprocessor, or the like.

The bus 802 may include a path for transmitting information between the above components. The bus 802 may be a PCI (Peripheral Component Interconnect) bus or an EISA (Extended Industry Standard Architecture) bus, or the like. The bus 802 may be divided into an address bus, a data bus, a control bus, and the like. For ease of representation, FIG. 8 only uses one thick line, but does not mean that there is only one bus or one type of bus.

The memory 803 may be a ROM (Read Only Memory) or other types of static storage devices that can store static information and instructions, a RAM (Random Access Memory) or other types of dynamic storage devices that can store information and instructions, or an EEPROM (Electrically Erasable Programmable Read Only Memory), a CD-ROM (Compact Disc Read Only Memory) or other optical disk storage, optical disk storage (including compressed optical disk, laser disk, optical disk, digital versatile disk, Blu-ray disk, or the like), a magnetic disk storage medium or other magnetic storage device, or any other medium that can be used to carry or store the desired program code in the form of instructions or data structures and can be accessed by a computer, but is not limited thereto.

The memory 803 is used to store application code for executing the solution of the present disclosure, and the execution is controlled by the processor 801. The processor 801 is used to execute the application code stored in the memory 803 to implement the content shown in the above method embodiment.

The electronic devices include, but are not limited to, mobile phones, laptop computers, digital broadcast receivers, PDAs (personal digital assistants), PADs (tablet computers), PMPs (portable multimedia players), vehicle-mounted terminals (such as vehicle-mounted navigation terminals), or the like, and fixed terminals such as digital TVs, desktop computers, etc. The electronic device shown in FIG. 8 is only an example and should not impose any limitation on the functions and scope of application of the embodiments of the present disclosure.

The embodiment of the present disclosure may be an independent physical server, or a server cluster or distributed system including multiple physical servers, or a cloud server that provides basic cloud computing services such as cloud services, cloud databases, cloud computing, cloud functions, cloud storage, network services, cloud communications, middleware services, domain name services, security services, CDN, and big data and artificial intelligence platforms. The terminal may be a smart phone, tablet computer, laptop computer, desktop computer, smart speaker, smart watch, or the like, but is not limited thereto. The terminal and the server may be directly or indirectly connected via wired or wireless communication, which is not limited by the present disclosure.

An embodiment of the present disclosure provides a computer-readable storage medium, on which a computer program is stored. When the computer-readable storage medium is run on a computer, the computer can execute the corresponding contents of the aforementioned method embodiment.

It should be understood that, although the steps in the flowchart of the accompanying drawings are displayed in sequence as indicated by the arrows, these steps are not necessarily executed in sequence in the order indicated by the arrows. Unless otherwise specified herein, there is no strict order restriction on the execution of these steps, and they can be executed in other orders. Moreover, at least a part of the steps in the flowchart of the accompanying drawings may include multiple sub-steps or multiple stages, and these sub-steps or stages are not necessarily executed at the same time, but can be executed at different times, and their execution order is not necessarily sequential, but can be executed in turn or alternately with other steps or at least a part of the sub-steps or stages of other steps.

It should be noted that the computer-readable medium mentioned above in the present disclosure may be a computer-readable signal medium or a computer-readable storage medium or any combination of the above two. The computer-readable storage medium may be, for example, but not limited to, an electrical, magnetic, optical, electromagnetic, infrared, or semiconductor system, apparatus or device, or any combination of the above. More specific examples of computer-readable storage media may include, but are not limited to: an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, a computer-readable storage medium may be any tangible medium containing or storing a program that can be used by or in combination with an instruction execution system, apparatus or device. In the present disclosure, a computer-readable signal medium may include a data signal propagated in a baseband or as part of a carrier wave, which carries a computer-readable program code. This propagated data signal may take a variety of forms, including but not limited to electromagnetic signals, optical signals, or any suitable combination of the above. The computer readable signal media may also be any computer readable medium other than computer readable storage media, which may send, propagate or transmit a program for use by or in conjunction with an instruction execution system, apparatus or device. The program code contained on the computer readable medium may be transmitted using any appropriate medium, including but not limited to: wires, optical cables, RF (radio frequency), etc., or any suitable combination of the above.

The computer-readable medium may be included in the electronic device, or may exist independently without being installed in the electronic device.

The computer-readable medium carries one or more programs. When the one or more programs are executed by the electronic device, the electronic device executes the method shown in the above embodiment.

According to one aspect of the present disclosure, a computer program product or a computer program is provided, the computer program product or the computer program comprising computer instructions, the computer instructions being stored in a computer-readable storage medium. A processor of a computer device reads the computer instructions from the computer-readable storage medium, and the processor executes the computer instructions, so that the computer device executes the methods provided in the above-mentioned various optional implementations.

The computer program code for carrying out operations of the embodiment of the present disclosure may be written in one or more programming languages or a combination thereof, including object-oriented programming languages such as Java, Smalltalk, C++, and conventional procedural programming languages such as “C” or similar programming languages. The program code may be executed entirely on the user's computer, partially on the user's computer, as a separate software package, partially on the user's computer and partially on a remote computer, or entirely on a remote computer or server. In cases involving a remote computer, the remote computer may be connected to the user's computer through any type of network, including a local area network (LAN) or a wide area network (WAN), or may be connected to an external computer (e.g., via the Internet using an Internet service provider).

The flow chart and block diagram in the accompanying drawings illustrate the possible architecture, function and operation of the system, method and computer program product according to various embodiments of the present disclosure. In this regard, each block in the flow chart or block diagram can represent a module, a program segment or a part of a code, and the module, the program segment or a part of the code contains one or more executable instructions for realizing the specified logical function. It should also be noted that in some implementations as alternatives, the functions marked in the block can also occur in a sequence different from that marked in the accompanying drawings. For example, two blocks represented in succession can actually be executed substantially in parallel, and they can sometimes be executed in the opposite order, depending on the functions involved. It should also be noted that each block in the block diagram and/or flow chart, and the combination of the blocks in the block diagram and/or flow chart can be implemented with a dedicated hardware-based system that performs a specified function or operation, or can be implemented with a combination of dedicated hardware and computer instructions.

The modules involved in the embodiments described in the present disclosure may be implemented by software or hardware. The name of a module does not limit the module itself in some cases. For example, module A may also be described as “module A for performing operation B”.

The above description is only a preferred embodiment of the present disclosure and an exscheduleation of the technical principles used. Those skilled in the art should understand that the scope of disclosure involved in the present disclosure is not limited to the technical solutions formed by a specific combination of the above technical features, but should also cover other technical solutions formed by any combination of the above technical features or their equivalent features without departing from the above disclosed concept. For example, a technical solution formed by replacing the above features with technical features with similar functions disclosed in this disclosure (but not limited thereto).

1. A power save mode period negotiation method, applied to a first access point device (AP), and comprising:
obtaining restricted target wake time service period (R-TWT SP) information of a neighboring AP; and
scheduling power save mode period of the first AP under at least one link based on a manner in which the R-TWT SP information of the neighboring AP is obtained, wherein the power save mode period and a time indicated by the R-TWT SP information are overlapped or not overlapped.

2. The power save mode period negotiation method according to claim 1, wherein the manner in which the R-TWT SP information is obtained comprises:
receiving the R-TWT SP information broadcast by the neighboring AP;
or
receiving the R-TWT SP information of the neighboring AP shared by a second AP.

3. The power save mode period negotiation method according to claim 2, wherein the scheduling power save mode period of the first AP under at least one link based on the manner in which the R-TWT SP information of the neighboring AP is obtained comprises:
scheduling the power save mode period of the first AP under at least one link to be overlapped with the time indicated by the R-TWT SP information, wherein the R-TWT SP information is obtained from broadcasting of the neighboring AP.

4. The power save mode period negotiation method according to claim 1, wherein a Broadcast TWT Parameter Set field of the R-TWT SP information comprising first identification information, wherein, the first identification information indicates a range of the connection to which the R-TWT SP information is applied, and wherein the scheduling power save mode period of the first AP under at least one link comprises:
scheduling the power save mode period of the first AP under broadcast link; wherein the applied range of the link indicated by the first identification information comprises: the broadcast link of the broadcast R-TWT SP information;
or
scheduling the power save mode period of the first AP under multiple links; wherein, the applied range of the link indicated by the first identification information comprises the multiple links, and TID information of the broadcast link indicates that a service transmitted by the broadcast link is a low-latency service.

5. The power save mode period negotiation method according to claim 3, further comprising
scheduling the power save mode period of the first AP under a first link to be not overlapped with the time indicated by the R-TWT SP information, wherein the first link and the broadcast link are mutually a simultaneous transmit/receive (STR) link pair.

6. The power save mode period negotiation method according to claim 2, wherein the scheduling power save mode period of the first AP under at least one link based on the manner in which the R-TWT SP information of the neighboring AP is obtained comprises:
scheduling the power save mode period of the first AP under at least one link to be overlapped with the time indicated by the R-TWT SP information, wherein the R-TWT SP information is shared by the second AP, and a communication record of the neighboring AP is monitored by the first AP.

7. A power save mode period negotiation method, applied to a neighboring AP, and comprising:
broadcasting R-TWT SP information of the neighbor AP;
wherein the R-TWT SP information indicates a first AP to schedule power save mode period of the first AP under at least one link based on a manner in which the R-TWT SP information of the neighboring AP is obtained, wherein the power save mode period and a time indicated by the R-TWT SP information are overlapped or not overlapped.

8. The power save mode period negotiation method according to claim 7, wherein a Broadcast TWT Parameter Set field of the R-TWT SP information comprising first identification information, wherein, the first identification information indicates a range of the link to which the R-TWT SP information is applied;
the R-TWT SP information indicates the first AP to: schedule the power save mode period of the first AP under broadcast link to be overlapped with the time indicated by the R-TWT SP information; wherein the applied range of the link indicated by the first identification information comprises: the broadcast link of the broadcast R-TWT SP information;
or
the R-TWT SP information indicates the first AP to: schedule the power save mode period of the first AP under multiple links to be respectively overlapped with the time indicated by the R-TWT SP information; wherein, the applied range of the link indicated by the first identification information comprises the multiple links, and TID information of the broadcast link indicates that a service transmitted by the broadcast link is a low-latency service.

9. The power save mode period negotiation method according to claim 7, wherein the R-TWT SP information the R-TWT SP information indicates the first AP to: schedule the power save mode period of the first AP under a first link to be not overlapped with the time indicated by the R-TWT SP information, wherein the first link and the broadcast link are mutually an STR link pair.

10. The power save mode period negotiation method according to claim 7, wherein the method further comprises:
sending the R-TWT SP information to a second AP to instruct the second AP to share the R-TWT SP information to the first AP.

11. A power save mode period negotiation method, applied to a second AP, and comprising:
receiving R-TWT SP information of a neighboring AP sent by the neighboring AP of a first AP, and sharing the R-TWT SP information with the first AP;
wherein the R-TWT SP information indicates the first AP to schedule power save mode period of the first AP under at least one link based on a manner in which the R-TWT SP information of the neighboring AP is obtained, wherein the power save mode period and a time indicated by the R-TWT SP information are overlapped or not overlapped.

12.-14. (canceled)

15. An electronic device, comprising a memory, a processor, and a computer program stored in the memory and executable on the processor, wherein the processor, when executing the program, implements the method according to claim 1.

16. A non-transient computer-readable storage medium, wherein a computer program is stored on the computer-readable storage medium, and the computer program, when executed by a processor, implements the method according to claim 1.

17. An electronic device, comprising a memory, a processor, and a computer program stored in the memory and executable on the processor, wherein the processor, when executing the program, implements the method according to claim 7.

18. An electronic device, comprising a memory, a processor, and a computer program stored in the memory and executable on the processor, wherein the processor, when executing the program, implements the method according to claim 11.

19. A non-transient computer-readable storage medium, wherein a computer program is stored on the computer-readable storage medium, and the computer program, when executed by a processor, implements the method according to claim 7.

20. A non-transient computer-readable storage medium, wherein a computer program is stored on the computer-readable storage medium, and the computer program, when executed by a processor, implements the method according to claim 11.
